(19) United States
(12) Patent Application Publication
(10) Pub. No.: US 2025/0348306 A1
(43) Pub. Date: Nov. 13, 2025

(54) INFORMATION PROCESSING DEVICE, INFORMATION PROCESSING METHOD, AND PROGRAM

(71) Applicant: Sharp NEC Display Solutions, Ltd., Tokyo (JP)

(72) Inventor: Masakazu KOBAYASHI, Tokyo (JP)

(21) Appl. No.: 19/278,070

(22) Filed: Jul. 23, 2025

Related U.S. Application Data
(63) Continuation of application No. PCT/JP2023/002266, filed on Jan. 25, 2023.

(51) Int. Cl. G06F 8/65

(52) U.S. Cl. CPC G06F 8/65

(57) ABSTRACT

An information processing device includes a main substrate, and a sub-substrate capable of communicating with the main substrate. The sub-substrate has a sub-storage that stores additional information indicating whether an additional function according to an update of a program executed on the main substrate has been added. The main substrate has a main storage that stores the program, an acquisitor that acquires the additional information stored in the sub-substrate when the information processing device is started up, and an operation controller that performs control so that an operation of the information processing device is restricted when the additional information acquired by the acquisitor indicates that the additional function has been added and the additional function is determined not to be supported on the basis of a version of the program.

### TECHNICAL FIELD

The present invention relates to an information processing device, an information processing method, and a program.

### BACKGROUND ART

By upgrading software installed in a device such as an electronic device, functions supported and services provided by the device may be added (for example, refer to Patent Document 1). An example of a function added in this manner is a function of implementing a billing scheme. In a billing scheme, for example, the execution of some pieces of processing in the device is restricted according to a billing status, and the processing is controlled so that it cannot be executed when no billing is made, and can be executed when a billing is made. Alternatively, in a billing scheme, an execution time is measured so that an amount equivalent to a time during which specific processing is executed can be collected in a form of billing. Such a billing scheme is applied to a business model in which, for example, a highly functional device is sold at a low price to promote sales, and funds are collected according to a subsequent billing.

### CITATION LIST

### Patent Document

Patent Document 1: Japanese Unexamined Patent Application, First Publication No. 2008-112404

### SUMMARY OF INVENTION

### Technical Problem

However, a highly functional device has a long maintenance period, and during the maintenance period, a substrate installed in the device may break down and be replaced. When a result of replacing the substrate is that a version of software installed on the replaced substrate is older than the version previously installed, it is expected that functions of a billing scheme previously applied to the device will no longer be recognized or supported. In this case, regardless of whether a billing is made, restrictions that have been implemented on specific processing in the device may be removed, and the billing scheme may no longer be valid. In addition, even if the substrate is not replaced, the billing scheme may also no longer be valid when the software installed on the device is downgraded by a user, or the like. For this reason, there has been a demand to be able to deal with cases in which the billing scheme having been previously applied to the device is no longer valid when the substrate is replaced or the software is downgraded.

In view of the problems described above, the present invention aims to provide an information processing device, an information processing method, and a program that can deal with cases in which, when a function is added by upgrading software installed in a device such as an electronic device, the added function is no longer executable due to a replacement of the substrate or downgrading of the software.

### Solution to Problem

According to one aspect of the present invention, an information processing device includes a main substrate, and a sub-substrate capable of communicating with the main substrate, in which the sub-substrate has a sub-storage that stores additional information indicating whether an additional function according to an update of a program executed on the main substrate has been added, and the main substrate has a main storage that stores the program, an acquisitor that acquires the additional information stored in the sub-substrate when the information processing device is started up, and an operation controller that performs control so that an operation of the information processing device is restricted when the additional information acquired by the acquisitor indicates that the additional function has been added and the additional function is determined not to be supported on the basis of a version of the program.

In addition, according to another aspect of the present invention, an information processing method performed by a computer that is an information processing device including a main substrate and a sub-substrate capable of communicating with the main substrate, in which the sub-substrate has a sub-storage that stores additional information indicating whether an additional function according to an update of a program executed on the main substrate has been added, and the main substrate has a main storage that stores the program, includes acquiring, by an acquisitor of the main substrate, the additional information stored in the sub-substrate when the information processing device is started up, and performing control, by an operation controller of the main substrate, so that an operation of the information processing device is restricted when the additional information acquired by the acquisitor indicates that the additional function has been added and when the additional function is determined not to be supported on the basis of a version of the program.

In addition, according to still another aspect of the present invention, a program causes a computer, that is an information processing device including a main substrate and a sub-substrate capable of communicating with the main substrate, in which the sub-substrate has a sub-storage that stores additional information indicating whether an additional function according to an update of a program executed on the main substrate has been added, and the main substrate has a main storage that stores the program, to execute acquiring the additional information stored in the sub-substrate when the information processing device is started up, and performing control so that an operation of the information processing device is restricted when the additional information acquired indicates that the additional function has been added and when the additional function is determined not to be supported on the basis of a version of the program.

### Advantageous Effects of Invention

According to the present invention, when a function is added by upgrading software installed in a device such as an electronic device, it is possible to cope with a case where the added function is no longer executed due to replacement of the substrate or downgrading of the software.

### BRIEF DESCRIPTION OF DRAWINGS

FIG. 1 A diagram representing an example of a hardware configuration of an information processing device in an embodiment.

FIG. 2 A diagram representing an example of information stored in a sub-substrate in a first embodiment.

FIG. 3 A diagram representing an example of additional information in the first embodiment.

FIG. 4 A flowchart representing a flow of processing performed by an operation controller in the first embodiment.

FIG. 5 A flowchart representing the flow of processing performed by the operation controller in the first embodiment.

FIG. 6 A diagram representing a basic configuration of the information processing device in the embodiment.

FIG. 7 A diagram representing an example of information stored in a sub-substrate in a second embodiment.

FIG. 8 A diagram representing an example of additional information in the second embodiment.

FIG. 9 A flowchart representing a flow of processing performed by an operation controller in the second embodiment.

FIG. 10 A flowchart representing the flow of processing performed by the operation controller in the second embodiment.

### DESCRIPTION OF EMBODIMENTS

Hereinafter, an embodiment of the present invention will be described.

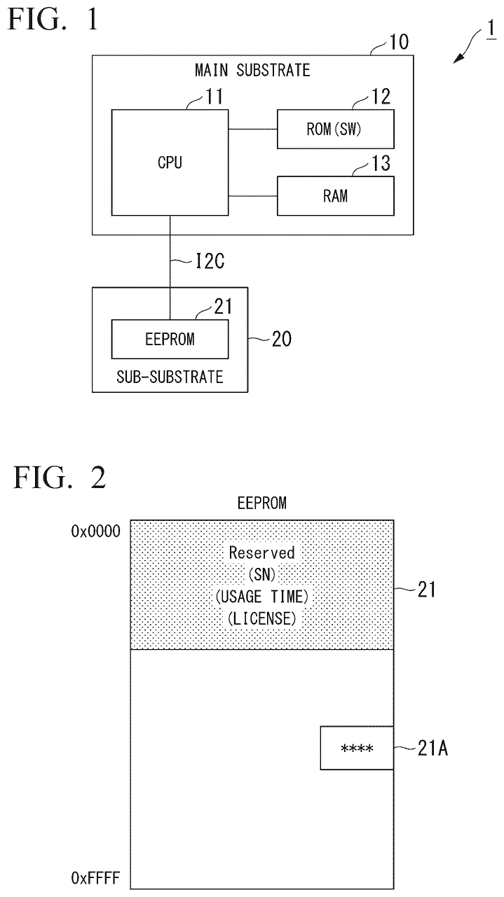

FIG. 1 is a diagram which shows an example of a hardware configuration of an information processing device 1 in the first embodiment. The information processing device 1 is a computer equipped with a function for processing information. For example, an image display device, a personal computer, a tablet terminal, a smartphone, or a mobile phone can be applied as the information processing device 1.

The information processing device 1 includes, for example, a main substrate 10 and a sub-substrate 20.

The main substrate 10 executes functions of the information processing device 1. The main substrate 10 includes a CPU 11, a ROM 12, and a RAM 13. These elements (the CPU 11, ROM 12, and RAM 13) are connected to each other via a bus or the like so that they can communicate with each other. That is, the main substrate 10 is equipped with the CPU 11, ROM 12, and RAM 13 so that they can communicate with each other.

The ROM 12 is a read-only memory and stores a program for executing the functions of the information processing device 1. In the present embodiment, the ROM 12 is a programmable ROM, in which information can be rewritten using a dedicated writing device (an ROM writer). For example, the ROM 12 is a NOR or NAND type flash memory. The RAM 13 is a readable and writable memory (a random access memory) that stores working data used when the CPU 11 executes processing. The CPU 11 executes the program stored in the ROM 12, and stores temporary data used when the program is executed in the RAM 13.

The sub-substrate 20 includes an EEPROM 21. The EEPROM 21 is connected to the main substrate 10 via a communication interface such as I2C so that they can communicate with each other. In other words, the EEPROM 21 is mounted on the sub-substrate 20 so that it can communicate with the main substrate 10.

The EEPROM 21 is a rewritable non-volatile memory (an electrically erasable programmable read-only memory). The EEPROM 21 stores information notified by the main substrate 10 in accordance with control of the main substrate 10. The EEPROM 21 also outputs the information stored in the EEPROM 21 to the main substrate 10 in accordance with the control.

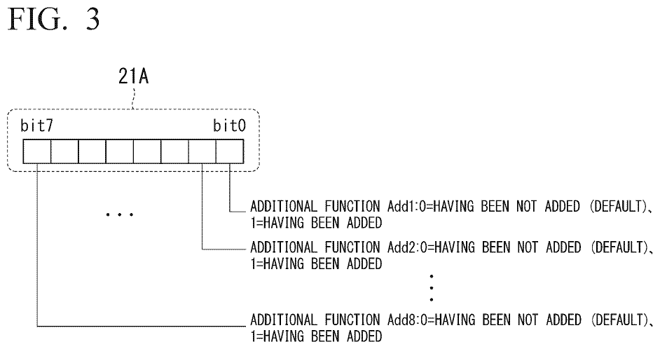

Information stored in the sub-substrate 20 will now be described using FIGS. 2 and 3. FIGS. 2 and 3 are diagrams which show examples of the information stored in the EEPROM 21 of the sub-substrate 20 in the first embodiment.

As shown in FIG. 2, information required to maintain the information processing device 1, such as a serial number (SN), usage time, license, and the like, is written to the EEPROM 21.

In the present embodiment, a specific area 21A is further reserved in the EEPROM 21, and information related to an additional function (additional information 202 which will be described below) can be written to the specific area 21A.

The additional function here is a function added by upgrading the program stored in the ROM 12 of the main substrate 10, such as a function of implementing a billing scheme.

In the billing scheme, whether to execute processing (hereinafter referred to as target processing) for realizing all or part of the functions provided in the information processing device 1 is controlled according to a billing status. In this case, for example, in the billing scheme, control is performed such that the target processing is not executed when no billing has been made, and the target processing is controlled to be executed when billing has been made. Alternatively, in the billing scheme, a time during which the target processing can be executed is determined according to a billing amount. In this case, when the target processing is executed, its execution time is measured, and the target processing is controlled so that it is executed until a remaining amount of billing, that is, a balance obtained by subtracting an amount equivalent to the execution time from the billing amount, becomes 0 (zero).

Here, the main substrate 10 has a more complex circuit configuration and has a larger number of components mounted thereon than other substrates mounted on the information processing device 1. For this reason, a risk of the main substrate 10 being replaced due to a failure of some components or circuits in the main substrate 10 is considered to be higher than other substrates.

Based on such a perspective, it is possible that the main substrate 10 will be replaced during a maintenance period of the information processing device 1. When the main substrate 10 is replaced, when a version of the program stored in the ROM 12 of the replaced main substrate 10 is older than the one previously implemented, functions of the billing scheme previously applied to the device will no longer be recognized or supported, and the target processing may be able to be executed indefinitely despite no billing having been made.

As a countermeasure to this, the information processing device 1 of the present embodiment is configured to store information related to the additional function on a substrate (the sub-substrate 20) that is physically different from the main substrate 10.

Specifically, the information related to the additional function is stored in a specific area 21A of the EEPROM 21 on the sub-substrate 20. As a result, even if the main substrate 10 is replaced and the functions of the billing scheme is no longer recognized or supported, it is possible to control the target processing so that it is not executed indefinitely on the basis of the information related to the additional function (here, a function of the billing scheme) stored in the specific area 21A.

FIG. 3 shows an example of the information stored in the specific area 21A of the EEPROM 21. As shown in the example of FIG. 3, for example, a storage area of 1 byte (8 bits) is reserved as the specific area 21A.

Here, an example is shown in which there are eight functions (additional functions Add1 to Add8) that are expected to be added in the future when the information processing device 1 is manufactured. It is also assumed that the program stored in the ROM 12 of the main substrate 10 applies a unified specification so that the eight functions (additional functions Add1 to Add8) correspond to each bit of the 1 byte (8 bits) in the specific area 21A regardless of the version of the program, in any version.

As shown in the example of FIG. 3, for example, each bit of one byte (8 bits) in the specific area 21A stores information indicating, in a binary value, whether a corresponding additional function has been added.

Specifically, when the information processing device 1 is manufactured, “0 (zero)” which is a value indicating that an additional function has not been added is set for each bit in the specific area 21A as an initial value (default). Thereafter, when the program is upgraded and an additional function is added to the upgraded program, “1” indicating that the additional function has been added is written to a bit in the specific area 21A corresponding to the added additional function.

More specifically, “0 (zero)” indicating that an additional function Add1 has not been added is set for (bit 0) in the specific area 21A as an initial value (default). Thereafter, when the additional function Add1 is added to the upgraded program, “1” indicating that the additional function Add1 has been added is set for the (bit 0) in the specific area 21A.

In addition, in, “0 (zero)” indicating that an additional function Add2 has not been added is set for (bit 1) in the specific area 21A as an initial value (default). Thereafter, when the additional function Add2 is added to the upgraded program, “1” indicating that the additional function Add2 has been added is set for the (bit 1) in the specific area 21A. The same applies to the other bits (bit 2 to bit 7).

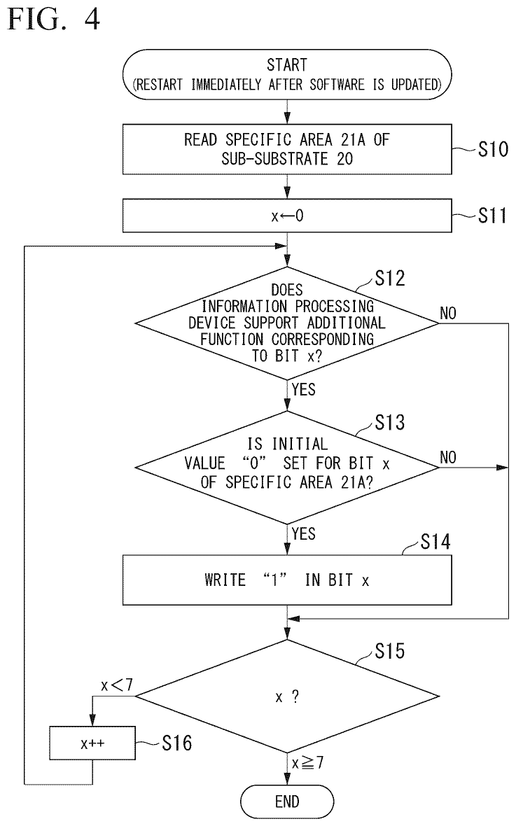

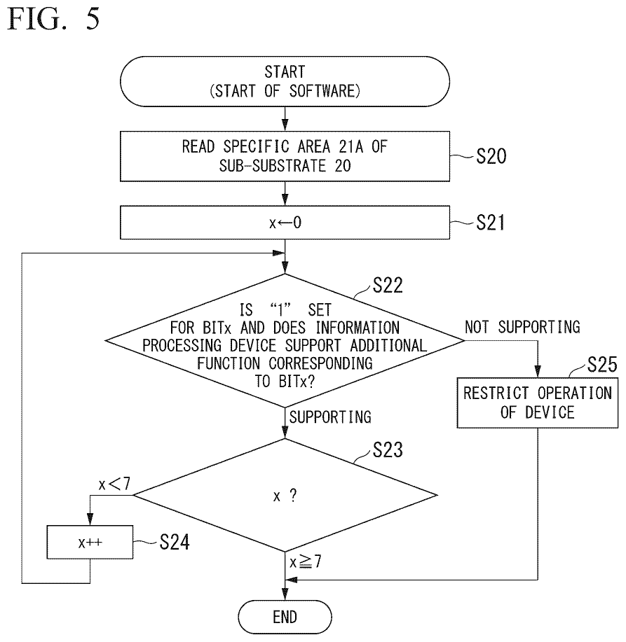

A flow of processing performed by the information processing device 1 will now be explained using FIGS. 4 and 5. FIGS. 4 and 5 are flowcharts which show the flow of processing performed by the information processing device 1 of the first embodiment.

FIG. 4 shows the flow of processing performed by the information processing device 1 when it is started up after software has been updated, for example, when the information processing device 1 is restarted immediately after the software has been updated.

The information processing device 1 reads the specific area 21A of the sub-substrate 20 (step S10). At a time of startup, the information processing device 1 refers to the EEPROM 21 in the sub-substrate 20 and acquires 8 bits of information (additional information 202) stored in the specific area 21A of the EEPROM 21. In addition, the information processing device 1 sets 0 (zero) for an initial value of a variable x, which is an internal variable (step S11).

The information processing device 1 determines whether it supports an additional function corresponding to a bit (bit x) in the specific area 21A that corresponds to a variable x (step S12). The information processing device 1 acquires a version of the program stored in the ROM 12, and determines whether it supports the additional function on the basis of the acquired version. For example, when the acquired version is a version of the program that includes the additional function, the information processing device 1 determines that it supports the additional function. On the other hand, when the acquired version is not the version of the program that includes the additional function, the information processing device 1 determines that it does not support the additional function.

When the additional function is supported, the information processing device 1 determines whether an initial value “0” is set for a bit x of the specific area 21A (step S13). When the initial value is set for the bit x, the information processing device 1 writes and stores “1” indicating that the additional function has been added in the bit x (step S14).

The information processing device 1 determines a value set for the variable x (step S15), and when a value less than 7 is set for the variable x, that is, (x<7), the information processing device 1 increments the variable x to increase it by 1 (step S16) and executes the processing shown in step S12.

On the other hand, when the information processing device 1 does not support the additional function corresponding to the bit x of the specific area 21A in step S12, and when “1” indicating that the additional function has already been added is set for the bit x of the specific area 21A in step S13, the information processing device 1 executes the processing shown in step S15.

In addition, when a value of 7 or greater is set for the variable x in step S15, the processing is ended.

FIG. 5 shows a flow of processing performed by the information processing device 1 when software is started up. Processing shown in steps S20 and S21 in FIG. 5 is similar to the processing shown in steps S10 and S11 in FIG. 4, and therefore description thereof will be omitted here.

The information processing device 1 determines whether “1” is set for the bit x in the specific area 21A and whether the information processing device 1 supports the additional function (step S22). A method by which the information processing device 1 determines whether the information processing device 1 supports the additional function is the same as a method used in the processing shown in step S12.

When “1” is set for the bit x, and the information processing device 1 supports the additional function, the information processing device 1 determines the value set for the variable x (step S23), and increments the variable x to increase it by 1 (step S24), and executes the processing shown in step S22 when a value less than 7 is set for the variable x, that is, (x<7).

On the other hand, when “1” is set for the bit x but the information processing device 1 does not support the additional function, the information processing device 1 restricts its own (information processing device 1) operation (step S25) and ends the processing. For example, the information processing device 1 controls the information processing device 1 so that it cannot be started by preventing the information processing device 1 from being powered on. In this manner, it is possible to prevent a situation in which the additional function added to the information processing device 1 is automatically set to “not added” due to a replacement of the main substrate 10, or the like, which causes and the billing scheme or the like to stop functioning.

Here, when “1” is set for the bit x but the information processing device 1 does not support the additional function, the information processing device 1 does not execute processing of writing “0” to the bit x. In other words, after writing “1” to the bit x, the operation controller 103 does not execute processing of returning the bit x to the initial setting value of “0,” regardless of whether the program written in ROM 12 supports the additional function. As a result, when the additional function is no longer supported due to replacement of the substrate or the like, an inconsistency will occur between the program written in ROM 12 and additional information written in the specific area 21A. Therefore, when the additional function is no longer supported due to the replacement of the substrate or the like, the information processing device 1 will be able to detect that the additional function that has been previously executable is no longer supported.

When, in step S22, “0” is set for the bit x and the information processing device 1 does not support the additional function corresponding to the bit x, the information processing device 1 proceeds to step S23. When, in step S22, “0” is set for the bit x and the information processing device 1 supports the additional function, the information processing device 1 writes and stores “1” to the bit x, as in step S14, and proceeds to step S23.

This makes it possible to control the information processing device 1 so that it does not start up when an inconsistency occurs, such as when the information processing device 1 does not support an additional function due to the replacement of the main substrate 10 or the like even though it is indicated that the additional function has been added to the specific area 21A. Therefore, even if additional functions such as a billing scheme that have been applied to the information processing device 1 are no longer supported due to the replacement of the main substrate 10, it is possible to prevent a situation from occurring in which target processing for which billing is made becomes executable indefinitely.

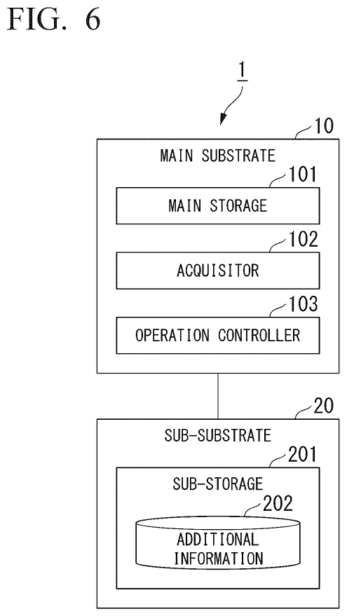

FIG. 6 is a diagram which shows a basic configuration of the information processing device 1 according to the present invention. The information processing device 1 includes a main substrate 10 and a sub-substrate 20.

The sub-substrate 20 includes a sub-storage 201. The sub-storage 201 corresponds to the EEPROM 21. The sub-storage 201 stores the additional information 202. The additional information 202 is information that indicates whether an additional function has been added, depending on an update of a program executed on the main substrate 10. That is, the sub-substrate 20 has the sub-storage 201 that stores the additional information 202 indicating whether an additional function has been added depending on the update of the program executed on the main substrate 10.

The main substrate 10 includes a main storage 101, an acquisitor 102, and an operation controller 103. The main storage 101 corresponds to the ROM 12. The main storage 101 stores the program executed on the main substrate 10.

The acquisitor 102 and the operation controller 103 are realized by the CPU 11 executing the program stored in the main storage 101. The acquisitor 102 acquires the additional information 202 stored in the sub-substrate 20 when the information processing device 1 is started up. When the additional information 202 acquired by the acquisitor 102 indicates that an additional function has been added, and when it is determined that the additional function is not supported on the basis of a version of the program stored in the main storage 101, the operation controller 103 controls the information processing device 1 so that it is not started up.

As described above, the information processing device 1 according to the first embodiment is a device that includes the main substrate 10 and the sub-substrate 20 capable of communicating with the main substrate 10. The sub-substrate 20 has the sub-storage 201 that stores the additional information 202 indicating whether an additional function has been added depending on the update of the program executed on the main substrate 10. The acquisitor 102 acquires the additional information 202 stored in the sub-substrate 20 when the information processing device 1 is started up. When the additional information 202 acquired by the acquisitor 102 indicates that an additional function has been added, and when it is determined that the additional function is not supported on the basis of the version of the program stored in the main storage 101, the operation controller 103 performs control so that an operation of the information processing device 1 is restricted.

As a result, in the information processing device 1 of the first embodiment, the additional information 202 can be stored in the sub-substrate 20, which is a substrate physically different from the main substrate 10. When an additional function is no longer supported due to the replacement of the main substrate 10, it is possible to detect that the additional function is no longer supported by creating an inconsistency between the information stored in the additional information 202 and functions supported by the program of the main substrate 10. In addition, even though an additional function is added by an update, when the additional function is no longer supported due to the replacement of the substrate thereafter, it is possible to perform control so that the operation of the information processing device 1 is restricted, for example, the information processing device 1 is not started up. Therefore, when a function is added by upgrading software installed in a device such as an electronic device, it is possible to prevent a situation in which the information processing device 1 is started up in a state in which the additional function (for example, a function related to a billing scheme) is not executed due to the replacement of the substrate or downgrading of the software.

In the information processing device 1 according to the first embodiment, information indicating that an additional function has not been added is set for the additional information 202 as the initial setting value. When the additional information 202 acquired by the acquisitor 102 indicates that an additional function has not been added and a program supporting the additional function has been written to the main storage 101, the operation controller 103 executes update processing to rewrite the additional information 202 to information indicating that the additional function has been added. As a result, when the program is updated and an additional function is added, it is possible to reflect the addition of the additional function in the additional information 202.

In the information processing device 1 according to the first embodiment, the update processing is executed when the information processing device 1 is restarted after the program is updated. As a result, when an additional function is added as a result of the update of the program, it is possible to quickly reflect the addition of the additional function in the additional information 202.

Moreover, in the information processing device 1 according to the first embodiment, when the information indicating that an additional function has been added is stored in the additional information 202, the operation controller 103 stores information indicating, in a binary value, whether the additional function has been added. For example, when the information indicating that an additional function has been added is stored in the additional information 202, and when an additional function corresponding to each bit in the specific area 21A has been added, the operation controller 103 stores a “1” indicating that the additional function has been added in that bit. On the other hand, when an additional function has not been added, that is, when it has not been added, the operation controller 103 stores a “0 (zero)” indicating that the additional function has not been added in that bit. As a result, in the information processing device 1 according to the first embodiment, it is possible to indicate, in a binary value, whether an additional function has been added, and it is possible to store appropriate information as the additional information 202 without increasing a memory capacity reserved as the specific area 21A.

Here, a second embodiment will be described. In the present embodiment, a storage area of 32 bytes (4 bytes×8) is reserved as the specific area 21B. When an additional function is added, the version of the program supporting the added function is written in an area corresponding to each of the additional functions Add1 to Add8 in the specific area 21B. As a result, it is possible to prompt restoration of the additional function by presenting the version of the program written in the specific area 21B or the like, even if the main substrate 10 is replaced and an inconsistency between before and after the replacement occurs.

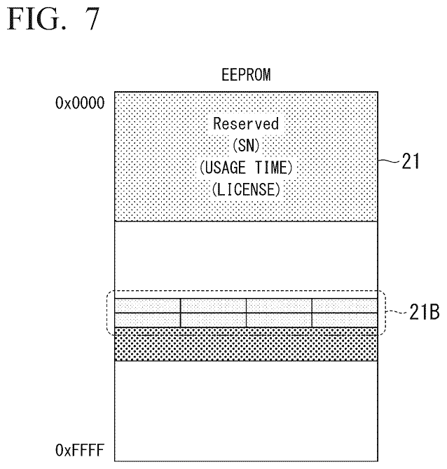

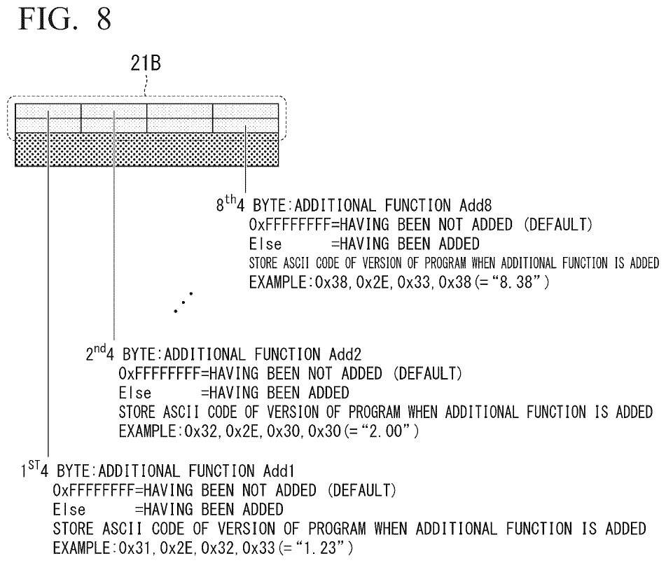

FIGS. 7 and 8 are diagrams which show examples of information stored in the EEPROM 21 of the sub-substrate 20 in the second embodiment.

As shown in an example of FIG. 7, the storage area of 32 bytes (4 bytes×8) is reserved as the specific area 21B. The specific area 21B is divided into eight areas of 4 bytes each, and is reserved as an area in which information related to each additional function, specifically the version of the program supporting the additional function, is written.

As shown in an example of FIG. 8, for example, in the 32-byte area in specific area 21B, for each 4-byte area, the version of the program that supports an additional function corresponding to each 4-byte area is stored.

Specifically, when the information processing device 1 is manufactured, “0xFFFFFFFF,” which is a value indicating that an additional function has not been added is set for each 4-byte area in the specific area 21B as an initial value (default). Thereafter, when the program is upgraded and an additional function is added to the upgraded program, a value different from the initial value (default), specifically, a version of the upgraded program (the program that supports the additional function), is written to a 4-byte area in the specific area 21B corresponding to the added additional function as a value indicating that the additional function has been added.

More specifically, “0xFFFFFFFF” indicating that the additional function Add1 has not been added is set for a first 4 bytes (1st 4 bytes) in the specific area 21B as the initial value (default). Thereafter, when the additional function Add1 is added to the upgraded program, information indicating a version of the upgraded program (the program that supports the additional function), for example, “0x31, 0x2E, 0x32, 0x33” indicating the version in ASCII code, is written in (the 1st 4 bytes) in the specific area 21B. In other words, information indicating that the version is “1.23” is set.

“0xFFFFFFFF” indicating that the additional function Add2 has not been added is set for a second 4 bytes (2nd 4 bytes) in the specific area 21B as the initial value (default). Thereafter, when the additional function Add2 is added to the upgraded program, information indicating a version of the upgraded program (the program that supports the additional function), for example, “0x32, 0x2E, 0x30, 0x30” indicating the version in ASCII code, is written in (2nd 4 bytes) in the specific area 21B. In other words, information indicating that the version is “2.00” is set. The same will be applied to other 4-byte areas (3rd 4 bytes, 4th 4 bytes, 5th 4 bytes, 6th 4 bytes, 7th 4 bytes, and 8th 4 bytes).

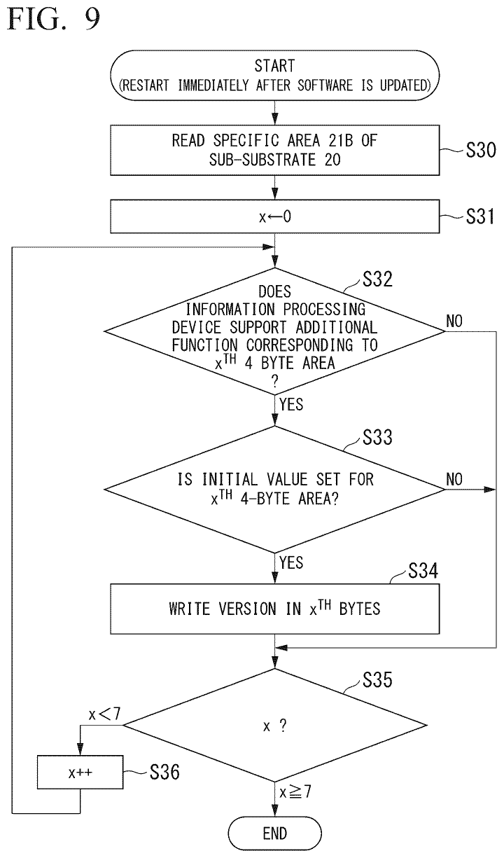

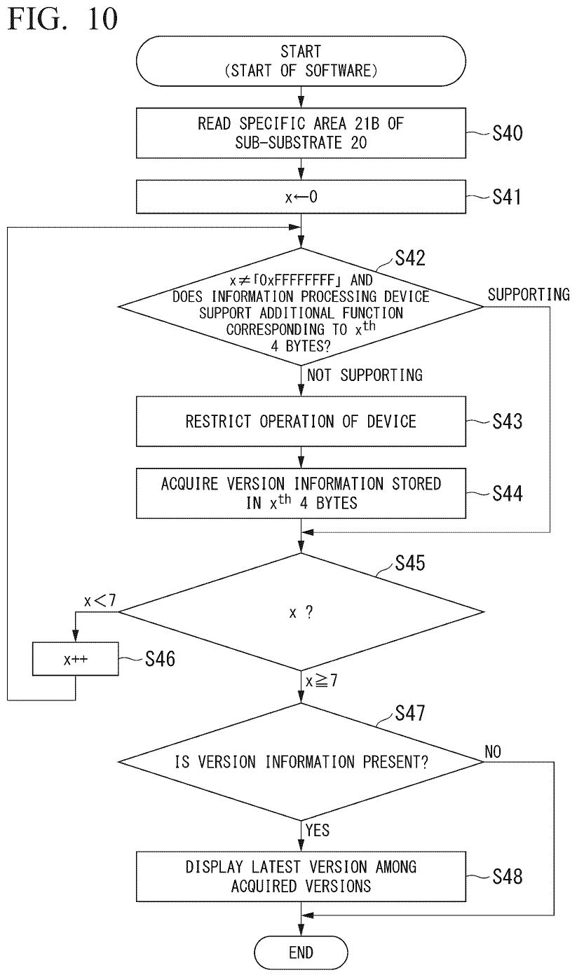

Here, a flow of processing performed by the information processing device 1 will be explained using FIGS. 9 and 10. FIGS. 9 and 10 are flowcharts which show the flow of processing performed by the information processing device 1 of the second embodiment.

FIG. 9 shows the flow of processing performed by the information processing device 1 when it is started up after software has been updated, for example, when the information processing device 1 is restarted immediately after the software has been updated.

The information processing device 1 reads the specific area 21B of the sub-substrate 20 (step S30). At a time of start-up, the information processing device 1 refers to the EEPROM 21 in the sub-substrate 20 and acquires 32 bytes of information (additional information 202) stored in the specific area 21B of the EEPROM 21. In addition, the information processing device 1 sets 0 (zero) for an initial value of a variable x, which is an internal variable (step S31).

The information processing device 1 determines whether it supports an additional function corresponding to an xth 4 bytes in the specific area 21B (for example, the 1st 4 bytes when x=0, the 2nd 4 bytes when x=1, and the like) (step S32). A method for determining whether the information processing device 1 supports an additional function is the same as in step S12, so a description thereof will be omitted.

When it supports the additional function, the information processing device 1 determines whether a value indicating that the additional function has been added, that is, a value different from the initial value (0xFFFFFFFF), is set for the xth 4 bytes (step S33). When the initial value is set for the xth 4 bytes, the information processing device 1 writes and stores the version of a currently upgraded program in the xth 4 bytes (step S34).

The information processing device 1 determines the value set for the variable x (step S35), and when a value less than 7 is set for the variable x, that is, (x<7), it increments the variable x to increase it by 1 (step S36) and executes the processing shown in step S32.

On the other hand, when the information processing device 1 does not support the additional function corresponding to the xth 4 bytes in step S32, and when a value different from the initial value is set for the xth 4 bytes in step S33, the information processing device 1 executes the processing shown in step S35.

Furthermore, when a value equal to or greater than 7 is set for the variable x in step S35, the processing will end.

FIG. 10 shows a flow of processing performed by the information processing device 1 when the software is started up. The processing shown in steps S40 and S41 in

FIG. 10 is similar to processing shown in steps S30 and S31 in FIG. 9, and therefore a description thereof will be omitted.

The information processing device 1 determines whether a value (the version of the program) different from the initial value (0xFFFFFFFF) is set for the xth 4 bytes in the specific area 21B and whether the information processing device 1 supports the additional function (step S42). The method by which the information processing device 1 determines whether the information processing device 1 supports the additional function is the same as the method used in the processing shown in step S12.

When the value (program version) different from the initial value is set for the xth 4 bytes and the information processing device 1 supports the additional function, the information processing device 1 determines the value set for the variable x (step S45), and when a value less than 7 is set for the variable x, that is, (x<7), the information processing device 1 increments the variable x to increase the set value of the variable x by 1 (step S46), and executes the processing shown in step S42.

On the other hand, when a value (the version of the program) different from the initial value is set for the xth 4 bytes but the information processing device 1 does not support the additional function, the information processing device 1 restricts the operation of the information processing device 1 (step S43). For example, the information processing device 1 controls the information processing device 1 so that it is not started up, for example by preventing it (the information processing device 1) from being powered on. The information processing device 1 acquires information (version information) indicating the version of the program stored in the xth 4 bytes (step S44).

The information processing device 1 proceeds to step S45.

Here, when a value (the version of the program) different from the initial value is set for the xth 4 bytes, but the information processing device 1 does not support the additional function, the information processing device 1 does not execute processing of writing the initial value to the xth 4 bytes. In other words, after writing the “version of the program” to the xth 4 bytes, the operation controller 103 does not execute processing of returning the xth 4 bytes to the initial setting value “0xFFFFFFFF,” regardless of whether the program written in the ROM 12 supports the additional function. As a result, an inconsistency is cased to occur between the program written in the ROM 12 and the additional information written in the specific area 21B when the additional function is no longer supported due to a replacement of the substrate, or the like. Therefore, when an additional function is no longer supported due to the replacement of the substrate, or the like, the information processing device 1 will be able to detect that the additional function that has been previously executable is no longer supported.

When the initial value is set for the xth 4 bytes in step S42 and the information processing device 1 does not support the additional function corresponding to the xth 4 bytes, the information processing device 1 proceeds to step S45. When the initial value is set for the xth 4 bytes in step S42 and the information processing device 1 supports that additional function, the information processing device 1 writes the version of the program stored in the ROM 12 to the xth 4 bytes as in step S34, and proceeds to step S45.

On the other hand, when a value of 7 or greater is set for the variable x in step S45, the information processing device 1 determines whether the version information acquired in step S44 is present, that is, whether the version is a released version (step S47). When the version information acquired in step S44 is present, the information processing device 1 displays a latest version of versions acquired in step S44 (step S48) and ends the processing. For example, the information processing device 1 outputs information indicating the latest version to a display device (not shown), thereby displaying the latest version on a display device. At this time, the information processing device 1 may display a comment indicating that it is not possible to start up because the software has been downgraded, together with the information indicating the latest version.

On the other hand, in step S47, when the version information acquired in step S44 is not present, the information processing device 1 ends the processing.

As described above, in the information processing device 1 according to the second embodiment, when the operation controller 103 stores information indicating that an additional function has been added in the additional information 202, it stores the version of the program that supports the additional function. As a result, the information processing device 1 according to the second embodiment can hold the version of the program in which the additional function is supported, and when the added function (for example, a function related to a billing scheme) cannot be executed due to the replacement of the substrate, or the like, it is possible to know what version of the program supports the additional function.

Moreover, in the information processing device 1 according to the second embodiment, when the additional information 202 acquired by the acquisitor 102 indicates that an additional function has been added and the version of the program in the ROM 12 does not support the additional function, the operation controller 103 displays the information indicated in the additional information 202 (the version of the program supporting the additional function). As a result, the information processing device 1 according to the second embodiment can display the version in which the additional function is supported. Therefore, when the substrate is replaced and an added function (for example, a function related to a billing scheme) cannot be executed, it is possible to prompt restoration of the additional function by presenting the user with the version in which the additional function is supported.

Furthermore, in the information processing device 1 according to the embodiment, the additional function is a function related to a billing scheme (a function that controls whether the information processing device 1 executes executable processing depending on a billing). As a result, the information processing device 1 of the embodiment can prevent occurrence of a situation in which processing that has been previously permitted to be executed according to billing becomes indefinitely executable, due to the replacement of the substrate, or the like.

Furthermore, in the information processing device 1 of the embodiment, the operation controller 103 does not execute processing of returning the additional information 202 to the initial setting value after the update processing is executed, regardless of whether the program written in the ROM 12 supports the additional function. As a result, in the information processing device 1 of the embodiment, when the additional function is no longer supported due to the replacement of the substrate or the like, an inconsistency may occur between the program written in the ROM 12 and the additional information written in the specific area 21A (21B). Therefore, the operation controller 103 can detect that an additional function that has been previously executable can no longer be executed due to a subsequent event, such as the replacement of the substrate.

In addition, a program for realizing each function of the information processing device 1 in FIG. 1 may be recorded on a computer-readable recording medium, and the program recorded on this recording medium may be read into a computer system and executed to perform position detection. Note that the term “computer system” here includes an OS and hardware such as peripheral devices.

In addition, when a WWW system is used, the term “computer system” also includes a home page providing environment (or a display environment). In addition, the “computer-readable recording medium” refers to a portable medium such as a flexible disk, an optical magnetic disc, a ROM, or a CD-ROM, or a storage device such as a hard disk embedded in the computer system. Furthermore, the term “computer-readable recording medium” includes a device that holds a program for a certain period of time, such as a volatile memory inside the computer system that serves as a server or client.

The program described above may be for realizing part of the functions described above, or may be capable of realizing the functions described above in combination with a program already recorded in the computer system. The program described above may be stored in a predetermined server, and distributed (downloaded, or the like) via a communication line in response to a request from another device.

Although the embodiments of the present invention have been described above in detail with reference to the drawings, a specific configuration is not limited to these embodiments, and designs and the like within a range not departing from the gist of the present invention are also included.

### REFERENCE SIGNS LIST

1 Information processing device
10 Main substrate
101 Main storage
102 Acquisitor
103 Operation controller
20 Sub-substrate
201 Sub-storage
202 Additional information

What is claimed is:

1. An information processing device that comprises a main substrate, and a sub-substrate configured to communicate with the main substrate,
wherein the sub-substrate comprises:
a sub-storage that stores additional information indicating whether an additional function according to an update of a program to be executed on the main substrate has been added, and
wherein the main substrate comprises:
a main storage that stores the program;
an acquisitor that acquires the additional information stored in the sub-substrate when the information processing device is started up; and
an operation controller that performs a control so that an operation of the information processing device is restricted when the additional information acquired by the acquisitor indicates that the additional function has been added and the additional function is determined not to be supported on the basis of a version of the program.

2. The information processing device according to claim 1,
wherein information indicating that the additional function has not been added is set for the additional information as an initial setting value, and
wherein the operation controller executes update processing to rewrite the additional information into information indicating that the additional function has been added when the additional information acquired by the acquisitor indicates that the additional function has not been added and the program supporting the additional function has been written to the main storage.

3. The information processing device according to claim 2,
wherein the operation controller executes the update processing when the information processing device is restarted after the program is updated.

4. The information processing device according to claim 2,
wherein, when the operation controller stores information indicating that the additional function has been added in the additional information, the operation controller stores information indicating in a binary value whether the additional function has been added.

5. The information processing device according to claim 2,
wherein the operation controller stores a version of the program supporting the additional function when information indicating that the additional function has been added is stored in the additional information.

6. The information processing device according to claim 5,
wherein the operation controller displays the version of the program indicated in the additional information when the additional information acquired by the acquisitor indicates that the additional function has been added and the version of the program does not support the additional function.

7. The information processing device according to claim 2,
wherein the operation controller does not execute processing of returning the additional information to the initial setting value after executing the update processing, regardless of whether the program supports the additional function.

8. The information processing device according to claim 1,
wherein the additional function is to control whether the information processing device executes executable processing depending on a billing.

9. An information processing method, performed by an information processing device comprising a main substrate and a sub-substrate configured to communicate with the main substrate, in which the sub-substrate comprises a sub-storage that stores additional information indicating whether an additional function according to an update of a program executed on the main substrate has been added, and the main substrate comprises a main storage that stores the program, the information processing method comprising:
acquiring, by an acquisitor of the main substrate, the additional information stored in the sub-substrate when the information processing device is started up; and
performing control, by an operation controller of the main substrate, so that an operation of the information processing device is restricted when the additional information acquired by the acquisitor indicates that the additional function has been added and when the additional function is determined not to be supported on the basis of a version of the program.

10. A non-transitory computer readable storage medium that stores a computer program causing a computer, that is an information processing device comprising a main substrate and a sub-substrate configured to communicate with the main substrate, in which the sub-substrate comprises a sub-storage that stores additional information indicating whether an additional function according to an update of a program executed on the main substrate has been added, and the main substrate comprises a main storage that stores the program, to execute:
acquiring the additional information stored in the sub-substrate when the information processing device is started up, and
performing control so that an operation of the information processing device is restricted when the additional information acquired indicates that the additional function has been added and when the additional function is determined not to be supported on the basis of a version of the program.
